(19) United States
(12) Patent Application Publication
(10) Pub. No.: US 2010/0187332 A1
(43) Pub. Date: Jul. 29, 2010

(54) COMMUNICATION TERMINAL

(75) Inventor: Tetsuya Ushijima, Yokohama-shi (JP)

Correspondence Address: Christensen O'Connor Johnson Kindness PLLC, 1420 Fifth Avenue, Suite 2800, Seattle, WA, 98101-2347, US

(73) Assignee: PANASONIC CORPORATION, Kadoma-shi, Osaka (JP)

(21) Appl. No.: 12/663,120

(22) PCT Filed: Jun. 25, 2007
(86) PCT No.: PCT/JP2007/062718

§ 371 Date: Dec. 4, 2009

(51) Int. Cl. B05B 15/00; H04W 88/00

(52) U.S. Cl. 239/289; 455/556.1

(57) ABSTRACT

A communication terminal not wastefully exuding aroma depending on the situation and not influencing the ambience of the terminal. The communication terminal (100) detects the situation around the portable terminal body (100B) by means of an aroma sensor (151) of a sensing unit (150), a camera (153), a microphone (154), an optical sensor (155), and a position sensor (156). An exudation/deodorization control section (131) of a control unit (130) makes aroma exudation control of an aroma exuding section (141) according to environment information on the environment of the portable terminal body (100B) detected by the sensing unit (150). With this, according to the situation around the portable terminal body (100B), wasteful exudation of aroma and adverse influence on the ambience of the terminal can be prevented wherever possible.

### TECHNICAL FIELD

The present invention relates to communication terminal apparatus, including a mobile phone having fragrance spreading functions for notifying incoming calls and schedules by spreading fragrance.

### BACKGROUND ART

In recent years, in the field of communication terminal apparatus such as mobile phones, it is becoming important to have not only the basic functions related to communication areas and communication speed, but also have an added value in an emotional aspect such as “fun” “amusing” like “ringtones” and “design.”

A mobile terminal apparatus with added value for notifying incoming calls, schedules and so on by spreading fragrance, is disclosed (see Patent Document 1). By this means, the user can recognize a notification such as an incoming call even in the situation where the user does not wear a mobile terminal apparatus. Further, a fragrance-producing mobile phone and utilization method thereof that entertains the user with fragrances according to senders of incoming calls or received email messages is disclosed (see Patent Document 2). By this means, it is possible to identify information received as input to a terminal by the sense of a smell.

### Patent Document 1: Japanese Patent Application Laid-Open No. 2005-318345

### Patent Document 2: Japanese Patent Application Laid-Open No. 2002-252686

### DISCLOSURE OF INVENTION

### Problems to be Solved by the Invention

Many requirements for spreading fragrance are proposed for communication terminal apparatuses such as conventional mobile terminal apparatus and fragrance-producing mobile phone. However, fragrance is spread every spreading request such as an incoming call without considering the situation related to surrounding the terminal, and therefore it is likely to spread fragrance uselessly.

It is therefore an object of the present invention to provide a communication terminal apparatus that can prevent fragrance from being spread uselessly and having influence on and around the terminal depending upon situations.

### Means for Solving the Problem

The communication terminal apparatus of the present invention adopts a configuration including: a fragrance spreading section that spreads fragrance by a predetermined spread request; a sensing section that acquires environment information about an environment in which the fragrance spreading section spreads the fragrance; and a spread control section that controls spread of the fragrance in the fragrance spreading section based on the environment information acquired in the sensing section.

### ADVANTAGEOUS EFFECTS OF INVENTION

According to the present invention, the spread of fragrance in a fragrance spreading section is able to be controlled by a spread control section based on environment information acquired by a sensing section, so that it is possible to prevent fragrance from being spread uselessly and having influence on and around the terminal depending upon situations.

### BRIEF DESCRIPTION OF DRAWINGS

FIG. 1 is a block diagram showing the configuration of a communication terminal apparatus according to an embodiment of the present invention;

FIG. 2 is a flow chart showing operations of the fragrance control requesting process in communication terminal apparatus according to an embodiment of the present invention;

FIG. 3 is a flow chart showing operations of fragrance spreading process in the communication terminal apparatus according to an embodiment of the present invention;

FIG. 4 is a flow chart showing operations of preliminary spreading process in the communication terminal apparatus according to an embodiment of the present invention;

FIG. 5 is a flow chart showing operations of spreading process in the communication terminal apparatus according to an embodiment of the present invention;

FIG. 6 is a flow chart showing operations of fragrance spreading stop (canceling) process in the communication terminal apparatus according to an embodiment of the present invention; and

FIG. 7 is a flow chart showing the operations of the spreading method determining process in the communication terminal apparatus according to an embodiment of the present invention.

### BEST MODE FOR CARRYING OUT THE INVENTION

A conventional communication terminal apparatus configured to notify an incoming call or an incoming email message by spreading fragrance, only spreads fragrance every incoming call. For this reason, with such a communication terminal apparatus, in cases where the user does not notice spread of fragrance, for example, when the user stays far from the terminal and strong wind and so on drowns out spreading fragrance soon, the fragrance is spread and therefore there has been a problem the fragrance material is consumed uselessly.

In view of the above-described problem, the present invention makes it possible to prevent fragrance from being spread uselessly and prevent the influence on and around the communication terminal apparatus according to the situation around the communication terminal apparatus, for example.

Now, embodiments of the present invention will be described in detail with reference to the accompanying drawings. Components and corresponding parts in the drawings having the same configurations or functions will be assigned the same reference numerals, and their explanations will not be repeated.

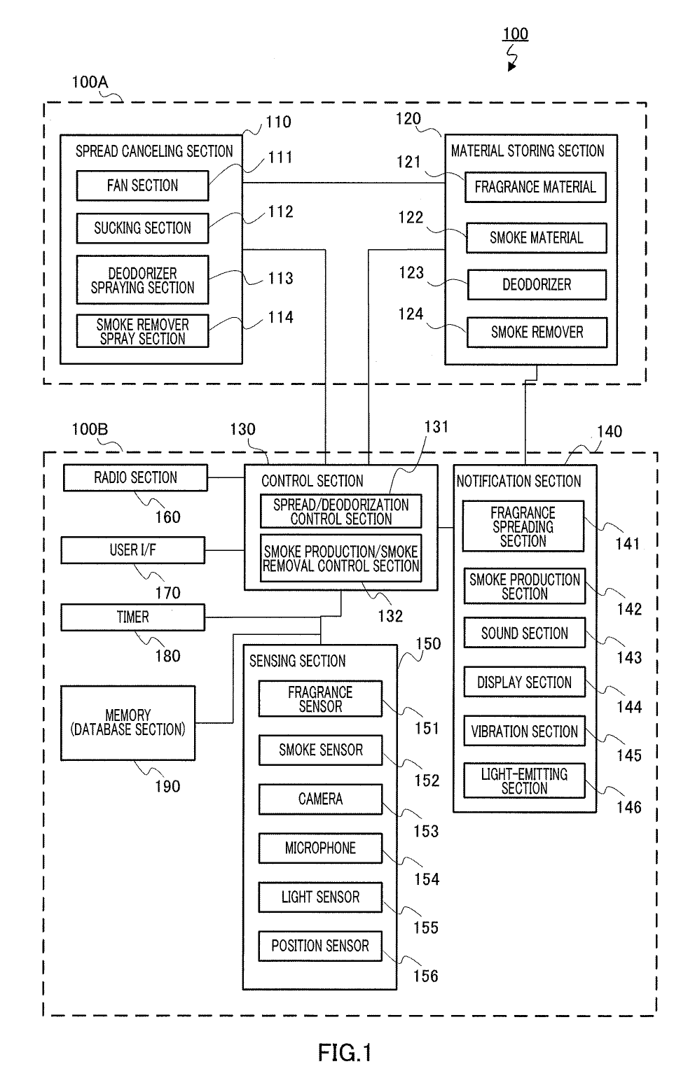

FIG. 1 shows the configuration of a communication terminal apparatus according to an embodiment of the present invention. This communication terminal apparatus 100 is mainly configured with two parts, that is, spreading apparatus body 100A that spreads fragrance, smoke and deodorizer, and mobile terminal body 100B that communicates via radio. Spreading apparatus body 100A may be integrated into mobile terminal body 100B or separate from mobile terminal body 100B. Here, in cases where spreading apparatus body 100A is apart from mobile terminal body 100B, it is desirable to enable the user to quickly recognize the spread of fragrance, for example, configuration assembling spreading apparatus body 100A into a desktop-holder-type battery charger for charging power of mobile terminal body 100B, or a configuration to enable the user to carry spreading apparatus body 100A.

Spreading apparatus body 100A in communication terminal 100 shown in the figure has spread canceling section 110 and material storing section 120. Spread canceling section 110 has fan section 111, sucking section 112, deodorizer spraying section 113 and smoke remover spray section 114, which are a means for removing spreading fragrance. Fan section 111 has a fan that blows out spread fragrance quickly, and cancels the spread of fragrance. Sucking section 112 has a sucking device that sucks in spreading fragrance quickly, and cancels the spread of fragrance. Deodorizer spraying section 113 has a deodorizer spray opening from which a deodorizer is sprayed on fragrance, and cancels the spread of the fragrance. Smoke remover spray section 114 has a smoke remover spray opening from which a smoke remover is sprayed on spread smoke, and cancels the spread of smoke. Here, fragrance (or smoke) is removed using the removal method the user sets up and selects in advance. For example, when the user selects the method of removing fragrance (smoke) with fan section 111, the blowing process is carried out by a fan. Further, when the user selects the method of removing fragrance (or smoke) by sucking section 112, a sucking device carries out the sucking process. Further, when the user selects the method of removing fragrance by deodorizer spraying section 113, the deodorizing process is carried out by issuing a spray of a deodorizer. Furthermore, when the user selects the method of removing smoke with smoke remover spray section 114, the smoke removing process is carried out by issuing a spray of a smoke remover.

Material storing section 120 has containers for storing fragrance material 121, smoke material 122, deodorizer 123 and smoke remover 124. Here, the container of fragrance material 121 is preferably a cartridge that accommodates a plurality of flavors including mint flavor, citrus flavor and aromatic flavor, and which can be replaced. Further, the containers of deodorizer 123 and smoke remover 124 are preferably gas cylinders that is sprayed on fragrance or smoke with deodorizer 123 and smoke remover 124 using nonflammable gas.

Meanwhile, mobile terminal apparatus body 100B in communication terminal apparatus 100 shown in the figures has control section 130, notification section 140, sensing section 150, radio section 160, user interface 170, timer 180 and memory 190. Control section 130 has spread/deodorization control section 131 and smoke production/smoke removal control section 132. Spread/deodorization control section 131 controls the spread of fragrance when fragrance material 121 in material storing section 120 spreads fragrance from fragrance spreading section 141 of notification section 140, and controls deodorization when deodorizer 123 in material storing section 120 is sprayed from deodorizer spraying section 113 of spread canceling section 110. Smoke production/smoke removal control section 132 controls the production of smoke when smoke material 122 in material storing section 120 produces smoke from smoke production section 142 of notification section 140, and controls smoke removal when smoke remover 124 in material storing section 120 is sprayed from smoke removal spray section 114 of spread canceling section 110.

Notification section 140 has fragrance spreading section 141, smoke production section 142, sound section 143, display section 144, vibration section 145 and light-emitting section 146, and notifies the user of an incoming call and so on using one or some of these sections. Fragrance spreading section 141 has a spreading hole from which fragrance is spread, and notifies the user of an incoming call and so on by spreading fragrance material 121 in material storing section 120 from the spreading hole into the air by a command from spread/deodorization control section 131. Smoke production section 142 has a spreading hole from which smoke is ejected, and notifies the user of an incoming call and so on by issuing a jet of smoke material 122 of material storing section 120 from the spreading hole by a command from smoke production/smoke removal control section 132. Sound section 143 notifies the user of an incoming call and so on by playing sounds and melodies (ringtones) through a speaker. Display section 144 notifies the user of an incoming call and so on by displaying information about the incoming call on a display configured with a liquid crystal panel and so on. Vibration section 145 notifies the user of an incoming call and so on by vibrating a vibrator. Light-emitting section 146 notifies the user of an incoming call and so on by blinking light-emitting elements such as LEDs.

The spreading hole from which the fragrance in fragrance spreading section 141 is spread, is configured to adjust the amount of fragrance spread or the direction of fragrance spread. For example, this spreading hole of fragrance spreading section 141, can be operated to limit the amount of fragrance spread when the amount of remaining fragrance material 121 to be spread is little and an environment related to surrounding the terminal is not suitable for spreading a large amount of fragrance. Further, this spreading hole can be operated to limit the output destination of fragrance when the direction of this fragrance spread is not preferable.

It is preferable that the color of a jet of smoke issued from the spreading hole of smoke production section 142 is white that can be colored by light-emitting diodes placed near the spreading hole. Similar to the spreading hole of fragrance spreading section 141, this spreading hole of smoke production section 142 can be operated to limit the amount of smoke when the amount of remaining smoke material 122 to produce smoke is little and the environment related to surrounding the terminal is not suitable for producing a large amount of smoke. Further, this spreading hole can be operated to limit the output destination of smoke when the direction of spreading smoke is not preferable.

Sensing section 150 has fragrance sensor 151, smoke sensor 152, camera 153, microphone 154, light sensor 155 and position sensor 156, and acquires environment information about the environment where fragrance is spread. Fragrance sensor 151 detects the types and moving direction of a smell floating near mobile terminal body 100B and sends the detection results to spread/deodorization control section 131. Smoke sensor 152 detects whether or not smoke is floating near mobile terminal body 100B, and sends the detection result to smoke production/smoke removal control section 132. Camera 153 detects whether or not the notification target user to be notified of an incoming call and so on by spreading fragrance, is near the terminal body, as to whether or not to have taken a photograph of the face of the user, and sends the detection result to control section 130. Microphone 154 detects wind power or wind direction near mobile terminal body 100B by collecting noise, and sends the detection result to control section 130. Light sensor 155 detects the open/closed state of the flip style mobile terminal body 100B and whether or not mobile terminal body 100B is placed indoors, from the magnitude of the amount of received light, and sends the detection results to control section 130. Position sensor 156 detects the current position of mobile terminal body 100B using GPS functions, and sends the detection result to control section 130.

Radio section 160 modulates or demodulates a transmission signal transmitted from mobile terminal body 100B and a received signal received from a communicating party, to transmit and receive the signal, and sends transmitted or received information to control section 130. User interface 170 sends user setting (operation) information including mode setting and mode switching of mobile terminal body 100B, to control section 130. Timer 180 measures the timing and duration of spreading fragrance and the timing and duration of issuing a jet of smoke set up by the user in advance, and sends the measurement results to control section 130. Memory 190 stores records of spreading fragrance and jets of smoke, and sends the kept information to control section 130 according to the user's request.

Although this communication terminal apparatus 100 adopts a configuration including fragrance spreading section 141, smoke production section 142, fragrance sensor 151 and smoke sensor 152 on the mobile terminal body 100B side, these may be provided on the spreading apparatus body 100A side.

Further, the fragrance spreading method for this communication terminal apparatus 100 is as follows:

(1) The open/closed electromagnetic valve scheme whereby the spreading hole of fragrance is opened or closed with an electromagnetic valve, to spread and stop fragrance;
(2) The heat/cool scheme whereby a sheet soaked with fragrance material 121 is heated or cooled, to spread and stop fragrance;
(3) The filter paper injection scheme whereby a filter paper is soaked with fragrance material 121 through an injection needle, to spread fragrance; and
(4) The spray nozzle scheme whereby a high-pressure gas sealing cylinder with a spray nozzle accommodates fragrance material 121, and fragrance is spread by pressing the nozzle.
Although any scheme may be implemented, in order to enable more accurate fragrance spread control, it is preferable to adopt (4) the spray nozzle scheme.

Next, the operations in communication terminal apparatus 100 of this example will be explained. With this communication terminal apparatus 100, various setting is conducted such as silent mode setting, mixed spreading setting, spreading holding setting, and mixing flavor parameter setting and timer setting.

In silent mode setting, in cases where the user is notified of an incoming call by “ringtones” or “spreading fragrance,” if these may cause trouble with others and fragrance material 121 may be consumed uselessly, the user operates setting for notifying a incoming call to use other notification methods that can prevent troubles with others and prevent fragrance material 121 from being consumed uselessly. In this communication terminal apparatus 100, this silent mode is set such that the notification setting upon receiving an incoming call for the user is switched to silent mode in which vibration section 145 drives (vibration) the vibrator and light-emitting section 146 blinks the light-emitting elements (LEDs) for example.

In mixed spreading setting, the operations in mobile terminal apparatus 100 are set up such that a fragrance mixing a plurality of fragrance materials 121 is produced and spread. For ease of explanation, cases where a fragrance is produced by using a single fragrance material 121 include here.

In spreading holding setting, when fragrance spread by the user is not possible, for example, when a decision is made that communication terminal apparatus 100 does not meet the conditions to spread fragrance, the operations in mobile terminal apparatus 100 are set up to hold the spread of fragrance. Here, whether or not communication terminal apparatus 100 meets the conditions to spread fragrance is decided depending on, for example, whether or not a silent mode is set up by user operations and whether or not environment information about mobile terminal body 100B detected in the sensors of sensing section 150 meets environmental conditions suitable for spreading fragrance. Here, the conditions where the spreading holding setting is carried out in this way, are referred to as “hold conditions.” This spreading holding setting is maintained until the silent mode setting of the above hold conditions is cleared and the environment of mobile terminal body 100B meets environment conditions suitable for spreading fragrance.

In the mixing flavor parameter setting, when a fragrance mixing a plurality of fragrance materials 121 is spread, a mixing condition (mixing parameter), that is, in what ratios a plurality of flavors selected from a plurality of fragrance materials 121 are mixed, is set up.

In the timer setting, when a fragrance spreading pattern is prepared in advance, timings and intervals of spread or hold of fragrance materials 121 corresponding to these spreading patterns are set up.

In communication terminal apparatus 100 of this example, processes such as the fragrance control requesting process, fragrance spreading process, preliminary spreading process, spreading process and fragrance spreading stop (canceling) process, are timely carried out.

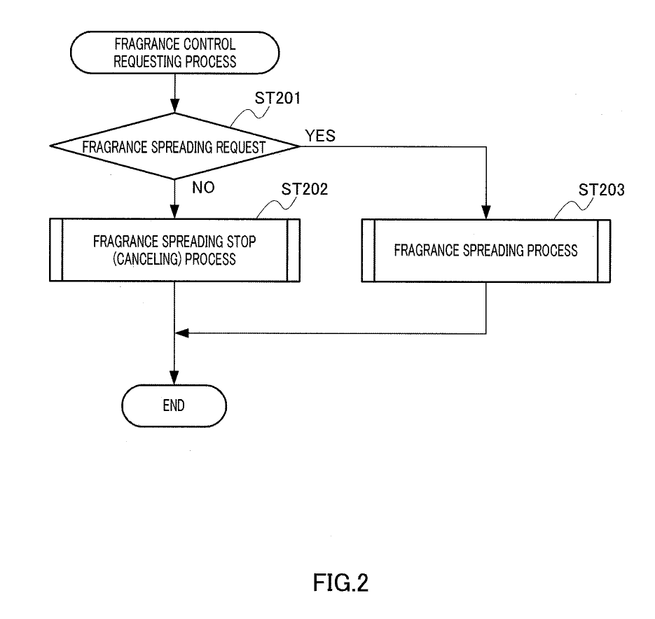

FIG. 2 shows a flow chart of the operations of the fragrance control requesting process. In this fragrance control requesting process, first, whether or not there is a fragrance spreading request is decided (step ST 201). For example, when the user sets up to notify an incoming call and so on by spreading fragrance, whether or not there is a fragrance spreading request is decided based on whether or not radio section 160 has received an incoming signal such as a phone call and a email message, that is, based on whether or not control section 130 has received an input of an incoming signal from radio section 160. When the user conducts a test for spreading fragrance, whether or not there is a fragrance spreading request is decided depending on whether or not control signal 130 receives an input of a fragrance spread test signal from user interface 170.

When a decision is made in step ST 201 that there is not a fragrance spreading request, the step moves to the fragrance spreading stop (canceling) process of canceling the fragrance spread (step ST 202). Further, when a decision is made in step ST 201 that there is a fragrance spreading request, the step moves to the fragrance spreading process of spreading fragrance (step ST 203).

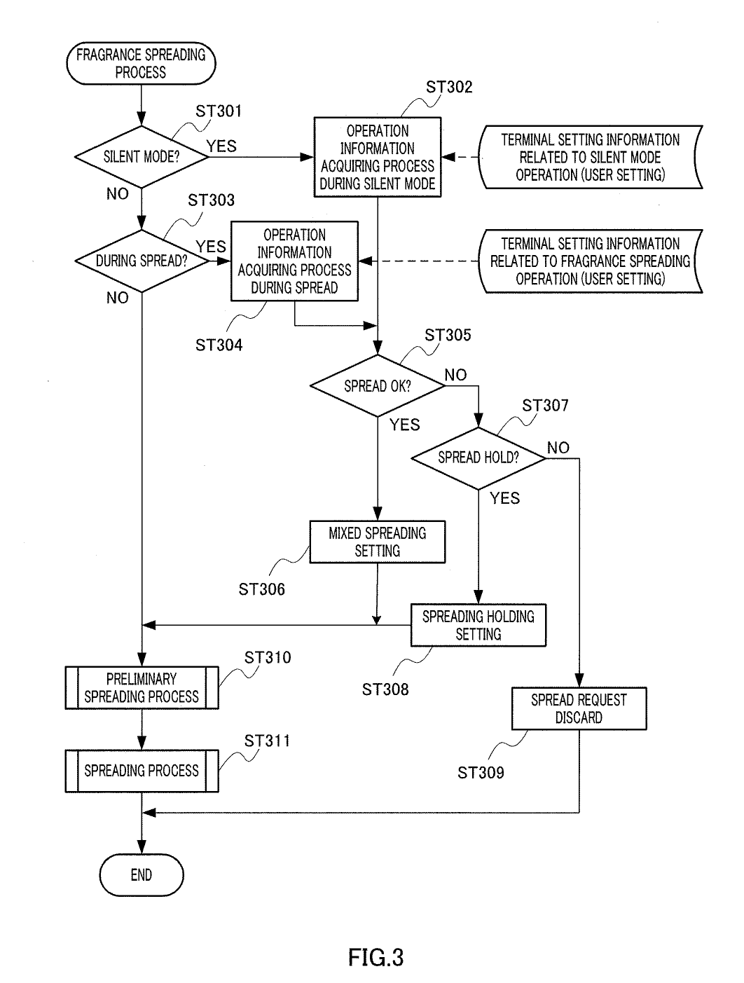

First, cases where there is a fragrance spreading request in step ST 201 and the fragrance spreading process of step ST 203 starts will be explained. FIG. 3 shows a flow chart of the operations of this fragrance spreading process.

In this fragrance spreading process, whether or not the notification setting for the user upon receiving a call in mobile terminal body 100B is the silent mode is decided (step ST 301). Here, when a decision is made that the notification setting is the silent mode, the operation information acquiring process during the silent mode is performed for acquiring terminal setting information (user settings) related to silent operations (terminal operations in the silent mode) (step ST 302).

On the other hand, when a decision is made in step ST 301 that the notification setting is not the silent mode, whether or not the fragrance spread by the previous spreading process is currently spreading is decided (step ST 303). Here, when a decision is made that the fragrance spread by the previous spreading process is currently spreading, the operation information acquiring process during spread is performed for acquiring terminal setting information (user settings) related to fragrance spreading operations (operations in the terminal upon spreading fragrance) (step ST 304).

Next, a decision is made as to whether or not fragrance spreading set by the user is possible, that is, whether or not it is permitted to spread fragrance based on the operation information acquired by the operation information acquiring process during the silent mode in step 302 or the operation information acquired by the operation information acquiring process during the spread in step ST 304 (step ST 305). Here, when a decision is made that it is permitted to spread fragrance, the operations in communication terminal apparatus 100 are set by the above mixed spreading setting so as to mix a new fragrance material 121 to be spread new and fragrance material 121 currently spreading and to spread the mixed fragrance (step ST 306).

On the other hand, when a decision is made in step ST 305 that it is not permitted to spread fragrance (i.e. it is no good to spread fragrance), whether or not to hold the spread of fragrance this time is decided (step ST 307). Here, when the user selects to hold the spread of fragrance this time, due to the above spreading holding setting, the operations in mobile terminal apparatus 100 are set up to hold the spread of fragrance this time (step ST 308). On the other hand, in step ST 307, when the user selects not to hold the spread of fragrance this time, the fragrance spreading request in step ST 201 is discarded (step ST 309) and the fragrance spreading process is finished.

Next, after the mixed spreading setting in step ST 306 and the spreading holding setting in step ST 308 are complete, or, when a decision is made in step ST 303 that the fragrance spread in the previous spreading process is not spreading, the preliminary spreading process is performed (step ST 310), and then the spreading process is performed (step ST 311) and the spreading process is finished.

In this way, with this fragrance spreading process, whether or not it is possible to spread fragrance set by the user, and whether or not communication terminal apparatus 100 spreads fragrance, are checked, and, in response to this spread request, a decision is made as to whether to spread fragrance, hold spreading fragrance, or discard the spread request.

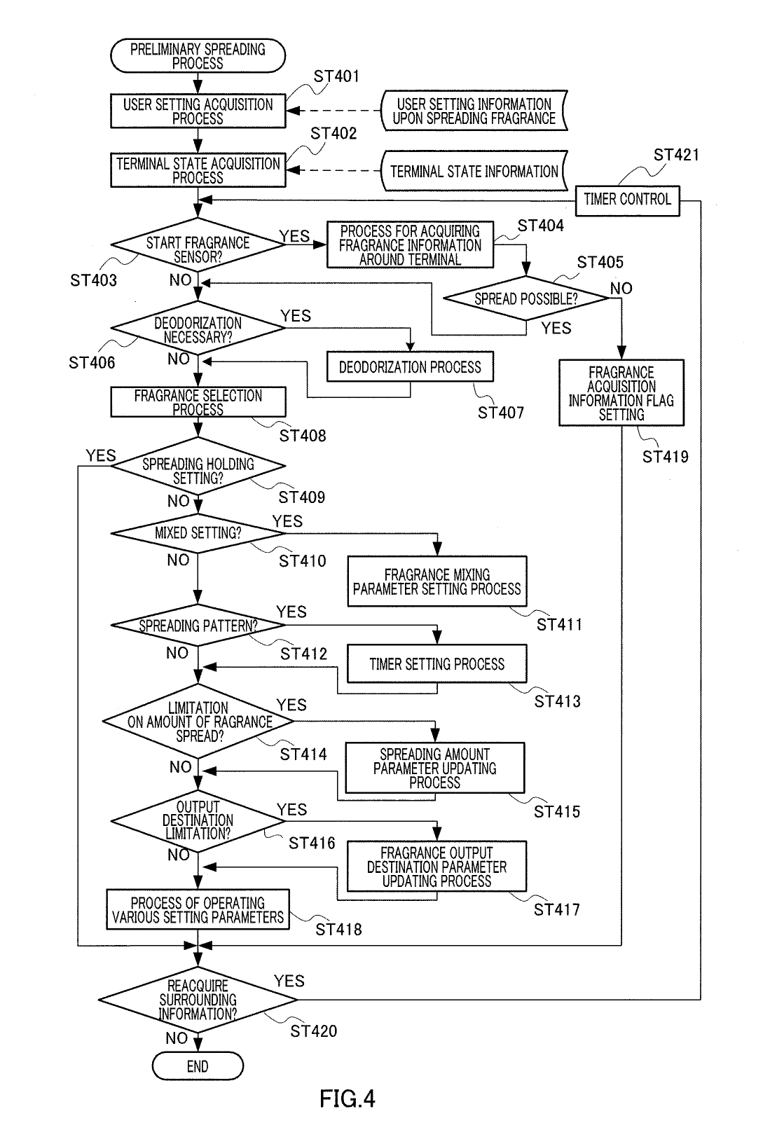

Next, the preliminary spreading process in step ST 310 will be described. FIG. 4 shows a flow chart of the operations of this preliminary spreading process. In this preliminary spreading process, first, the user setting acquisition process of acquiring user setting information upon spreading fragrance is performed (step ST 401), and next, terminal state acquisition process of acquiring terminal state information is preformed (step ST 402).

In the user setting acquisition process in step ST 401, user settings upon spreading fragrance, for example, the type of fragrance to be spread, the amount of fragrance spread, direction of fragrance spread (they are adjusted according to the angle of the spreading hole of fragrance spreading section 141) and spreading patterns of fragrance, are acquired.

Further, in the terminal state acquisition process in step ST 402, the state of communication terminal apparatus 100, for example, the style of mobile terminal body 100B (i.e. a open/closed state), the amount of remaining fragrance material 121 in material storing section 120, the environment related to surrounding mobile terminal body 100B (surrounding information) are acquired from the detection results of the sensors in sensing section 150.

Next, after the terminal state acquisition process in step ST 402 is complete, a decision is made as to whether or not fragrance sensor 151 of sensing section 150 is started (step ST 403). Here, when a decision is made that fragrance sensor 151 is started, process for acquiring the fragrance information around terminal is performed in order to acquire fragrance information including the types and moving direction of smell floating near mobile terminal body 100B (step ST 404). Then, from this fragrance information acquired in the process for acquiring the fragrance information around terminal, whether or not it is possible to spread fragrance is decided (step ST 405).

When a decision is made in step ST 405 that it is possible to spread fragrance, or when a decision is made in step ST 403 that fragrance sensor 151 does not start, whether or not it is necessary to deodorize a smell floating near mobile terminal body 100B is decided (step ST 406). Here, when a decision is made the deodorization is necessary, by operating at least one selected by the user from fan section 111, sucking section 112, deodorizer spraying section 113 of spread canceling section 110, the deodorization process of deodorizing the smell floating near mobile terminal body 100B is performed (step ST 407). Then, after this deodorization process is complete, or when a decision is made in step ST 406 that the deodorization is not necessary, the fragrance selection process of selecting the fragrance that the user has set up among a plurality of fragrance materials 121 of material storing section 120, is performed (step ST 408).

Next, after the fragrance selection process in step ST 408 is complete, whether the spreading holding setting in step ST 308 is set, is decided (step ST 409). Here, when a decision is made that the spreading holding setting is not performed, a decision is made as to whether or not to set up mixed spreading in the mixed spreading setting in step ST 306 (step ST 410).

When a decision is made in step ST 410 that mixed spreading is set, the fragrance mixing parameter setting process is performed in order to set up mixing conditions (mixing parameters), that is, in what ratios a plurality of flavors selected from a plurality of fragrance materials 121 are mixed (step ST 411). Then, after this fragrance mixing parameter setting process is complete, or when a decision is made in step ST 410 that a mixed spreading is not set, a decision is made as to whether or not there is a fragrance spreading pattern set by the user (step ST 412).

When a decision is made in step ST 412 that there is a spreading pattern, the timer setting process is performed in order to set up the timings and intervals of spread or hold of fragrance materials 121 according to this spreading pattern (step ST 413). Then, after this timer setting process is complete, or when a decision is made in step ST 412 that there is not a spreading pattern, a decision is made as to whether or not there is limitation to the amount of fragrance to be spread (step ST 414).

Here, when a decision is made in step ST 414 that there is limitation to the amount of spread, for example, the amount of remaining fragrance material 121 for spreading fragrance is little or the environment related to surrounding the terminal is not suitable for spreading a large amount of fragrance, fragrance spreading amount parameter updating process is performed in order to update the parameter of the amount of spreading fragrance (step ST 415). Then, after this fragrance spreading amount parameter updating process is complete, or when a decision is made in step ST 414 that there is no limitation to the amount of spread, whether or not destination is limited to output fragrance is decided (step ST 416).

Here, when a decision is made that the direction to spread fragrance is not preferable and there is limitation to the output destination in step ST 416, fragrance output destination parameter updating process is performed in order to update parameter of the output destination of fragrance (step ST 417). Then, after this fragrance output destination parameter updating process is complete, or when a decision is made in step ST 416 that there is no limitation on the output destination, process of operating the various setting parameters is performed in order to process operations by the above various setting parameters (step ST 418).

On the other hand, when a decision is made in step ST 405 that it is not possible to be spread, fragrance acquisition information flag setting is set in order to hold the fragrance acquisition information related to surrounding the terminal acquired in step ST 404 (step ST 419). Then, when a decision is made that there is either this fragrance acquisition information flag setting, the process of operating the various setting parameters in step ST 418, or the spreading holding setting in step ST 409, a decision is made as to whether or not to reacquire the information related to surrounding communication terminal apparatus 100 (step ST 420). Here, when a decision is made not to reacquire the surrounding information, the above preliminary spreading process is finished. On the other hand, when a decision is made to reacquire the surrounding information, timer 180 controls timings (step ST 421), to repeat, at a predetermined timing, the operations after step ST 403 to decide whether or not fragrance sensor 151 is started.

When a decision is made in step ST 405 that it is not possible to be spread, that is, when a decision is made that information related to surrounding the terminal is acquired and incoming call notification by spreading fragrance is not suitable from the acquired information, for example, in cases where the user stays at a place smelling strong, the information related to the surrounding the terminal is reacquired at arbitrary intervals and the timing to spread fragrance is in a wait, or a fragrance spreading request is discarded.

Further, when a decision is made in step ST 409 that there is spreading holding setting, the state of the terminal and information related to surrounding the terminal are acquired at arbitrary intervals until the hold condition is cleared or the spread request is discarded, and the fragrance spreading process is in a wait.

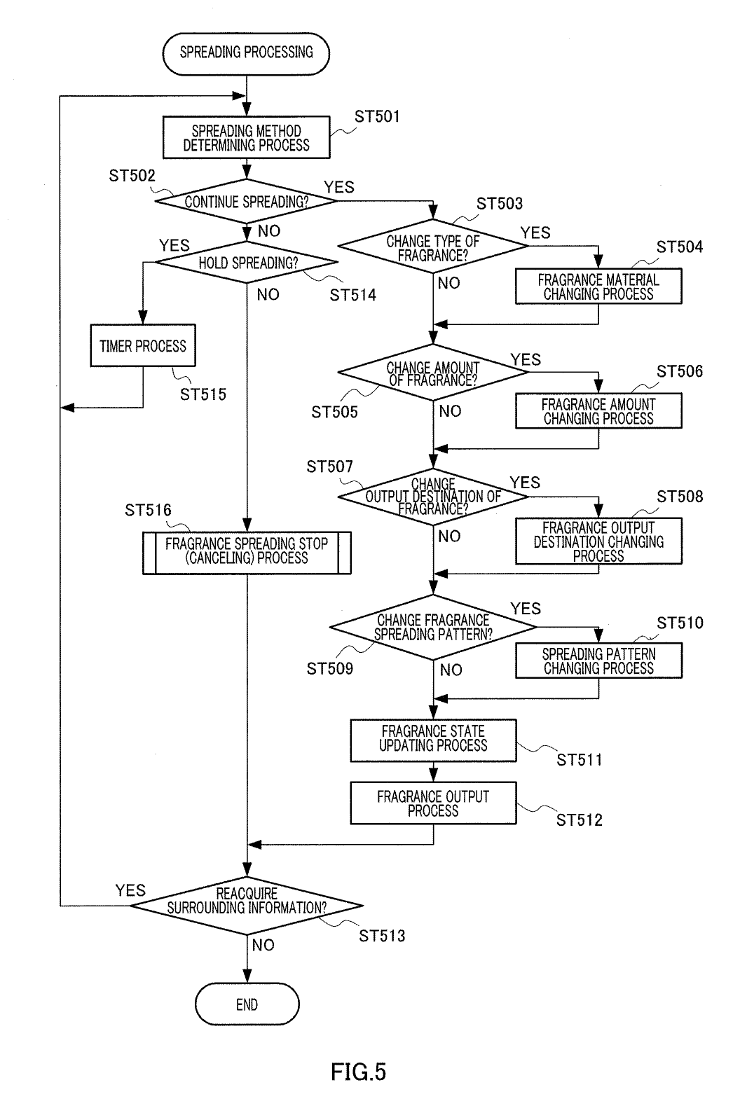

Next, the spreading process of step ST 311 will be explained. FIG. 5 shows a flow chart of the operations of the spreading process in step ST 311. In this spread process, first, a spreading method determining process of determining the spreading method for fragrance spread from fragrance spreading section 141 of mobile terminal body 100B is performed (step ST 501). Then, after this spreading method determining process is complete, a decision is made as to whether or not to continue spreading fragrance (step ST 502).

When a decision is made in step ST 502 to continue spreading fragrance, a decision is made as to whether or not to change the type of the fragrance to be spread (step ST 503). Here, when a decision is made to change the type of the fragrance, the fragrance material changing process is performed in order to change the type of fragrance material 121 of material storing section 120 (step ST 504). Then, after this fragrance material changing process is complete, or when a decision is made in step ST 503 not to change the type of the fragrance, whether or not to change the amount of fragrance to be spread is decided (step ST 505).

When a decision is made in step ST 505 to change the amount of fragrance, the fragrance amount changing process of changing the amount of fragrance to be spread is performed (step ST 506). Then, after this fragrance amount changing process is complete, or when a decision is made not to change the amount of the fragrance to be spread, a decision is made as to whether or not to change the output destination of the fragrance to be spread (step ST 507).

When a decision is made in step ST 507 to change the output destination of the fragrance, the fragrance output destination changing process is performed in order to change the output destination of the fragrance to be spread (step ST 508). Then, after this fragrance output destination changing process is complete, or when a decision is made in step ST 507 not to change the output destination of fragrance, whether or not to change the fragrance spreading pattern is decided (step ST 509).

When a decision is made in step ST 509 to change the fragrance spreading pattern, the spreading pattern changing process is performed in order to change the fragrance spreading pattern (step ST 510). Then, after this spreading pattern changing process is complete, or when a decision is made in step ST 509 not to change the fragrance spreading pattern, the fragrance state updating process is performed in order to update the state of the fragrance in communication terminal apparatus 100 (step ST 511).

Next, after the fragrance state updating process in step ST 511, the fragrance output process is performed in order to output fragrance from the spreading hole in fragrance spreading section 141 of notification section 140 (step ST 512). In this fragrance output process, also during spreading of fragrance, the state of spreading fragrance and the information related to surrounding the terminal are acquired regularly, and it is possible to change the type of the fragrance, the amount of fragrance, the output destination of fragrance, the spreading pattern and so on at arbitrary timings.

Then, after the fragrance output process in step ST 512, a decision is made as to whether or not to reacquire information related to surrounding communication terminal apparatus 100 (step ST 513). Here, when a decision is made not to reacquire surrounding information, the above spreading process is finished, and, when a decision is made to reacquire the surrounding information, the step returns to the spreading method determining process in step ST 501, to repeat the above spreading process.

On the other hand, when a decision is made in step ST 502 not to continue spreading fragrance, communication terminal apparatus 100 decides whether or not to hold the spread of fragrance (step ST 514). Here, when a decision is made to hold the spread, after timer 180 performs the timer process (step ST 515), the step returns to the spreading method determining process in step ST 501, to repeat the above spreading process. The timer process in step ST 515 is not a preliminary process, and is timing control in the series of the above spreading process.

Further, when decisions is made not to continue spreading fragrance in step 502 and not to hold the fragrance spread in communication terminal apparatus 100, after the fragrance spreading stop (canceling) process is performed in order to stop (cancel) spreading fragrance (step ST 516), the step moves to step ST 513 and a decision is made as to whether or not to reacquire information related to surrounding communication terminal apparatus 100.

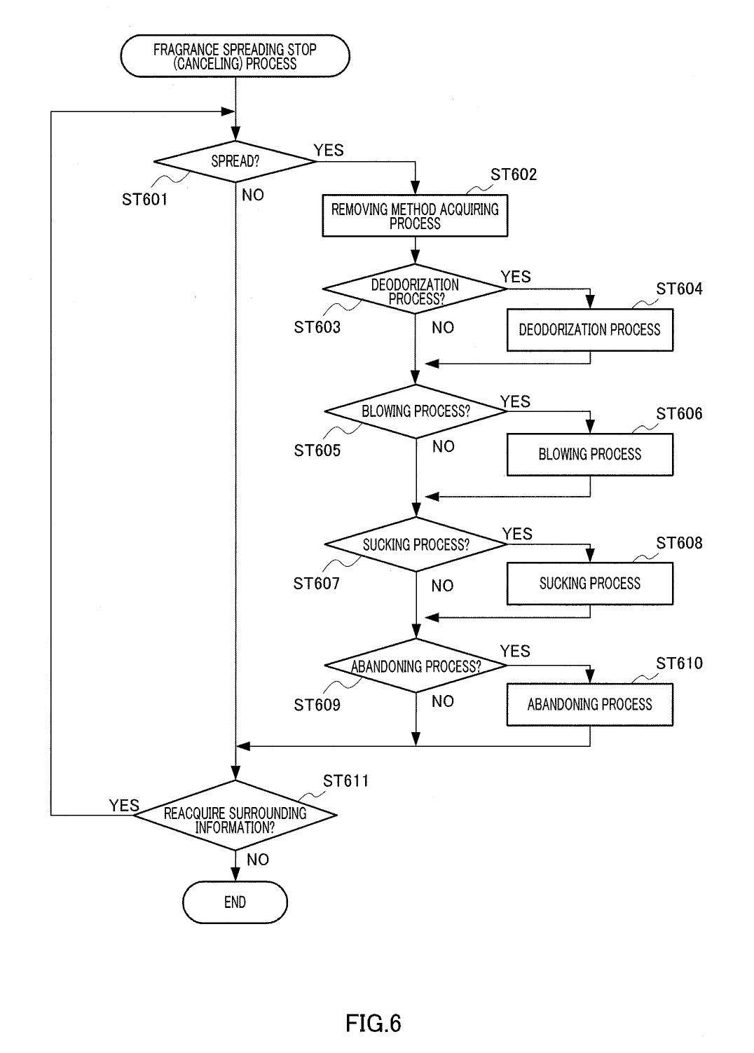

Next, the fragrance spreading stop (canceling) process in step ST 516 will be explained. FIG. 6 shows a flow chart of the operations of this fragrance spreading stop (canceling) process. In this fragrance spreading stop (canceling) process, first, whether or not to spread fragrance is decided (step ST 601). Here, when a decision is made to spread fragrance, the removing method acquiring process of selecting the method of canceling the spreading fragrance is performed (step ST 602). The remove method that can acquire in this removing method acquiring process include (1) deodorization process (2) blowing process (3) sucking process (4) abandoning process.

In this fragrance spreading stop (canceling) process, first, a decision is made as to whether or not to have selected the deodorization process in the removing method acquiring process in step ST 602 (step ST 603). Here, when a decision is made to select the deodorization process, the method of removing the fragrance by deodorizer spraying section 113 in spread canceling section 110, is selected, and the deodorization process is performed in order to spray the spreading fragrance with deodorizer 123 from the deodorizer spray opening, to deodorize the spreading fragrance (step ST 604).

Next, after the deodorization process is complete in step ST 604 or when a decision is made in step ST 603 not to select the deodorization process, a decision is made as to whether or not to have selected blowing process in the removing method acquiring process in step ST 602 (step ST 605). Here, when a decision is made to select the blowing process, the method of removing the fragrance by fan section 111 in spread canceling section 110, is selected, and the blowing process of driving the fan and blowing the spreading fragrance away, is performed (step ST 606).

Next, after the blowing process is complete in step ST 606 or when a decision is made in step ST 605 not to select the blowing process, a decision is made as to whether or not the sucking process has been selected in the removing method acquiring process in step ST 602 (step ST 607). Here, when a decision is made to select the sucking process, the method of removing the fragrance by sucking section 112 in spread canceling section 110, is selected, and the sucking process of driving a sucking device and sucking the spreading fragrance, is performed (step ST 608).

Next, after the sucking process is complete in step ST 608 or when a decision is made in step ST 607 not to select the sucking process, a decision is made as to whether or not the abandoning process has been selected in the removing method acquiring process in step ST 602 (step ST 609). Here, when a decision is made the abandoning process is selected, the removing method of waiting until the spreading fragrance fades away naturally, is selected, and the abandoning process for allowing the spreading fragrance to fade away naturally, is performed (step ST 610).

Next, after the abandoning process is complete in step ST 610, when a decision is made in step ST 609 not to select the abandoning process, or when a decision is made in step ST 601 not to spread fragrance, whether or not to reacquire information related to surrounding communication terminal apparatus 100 is decided (step ST 611). Here, when a decision is made not to reacquire surrounding information, the above fragrance spreading stop (canceling) process is finished and when a decision is made to reacquire surrounding information, the step returns to the decision in step ST 601 as to whether or not to spread fragrance, to repeat the fragrance spreading stop (canceling) process.

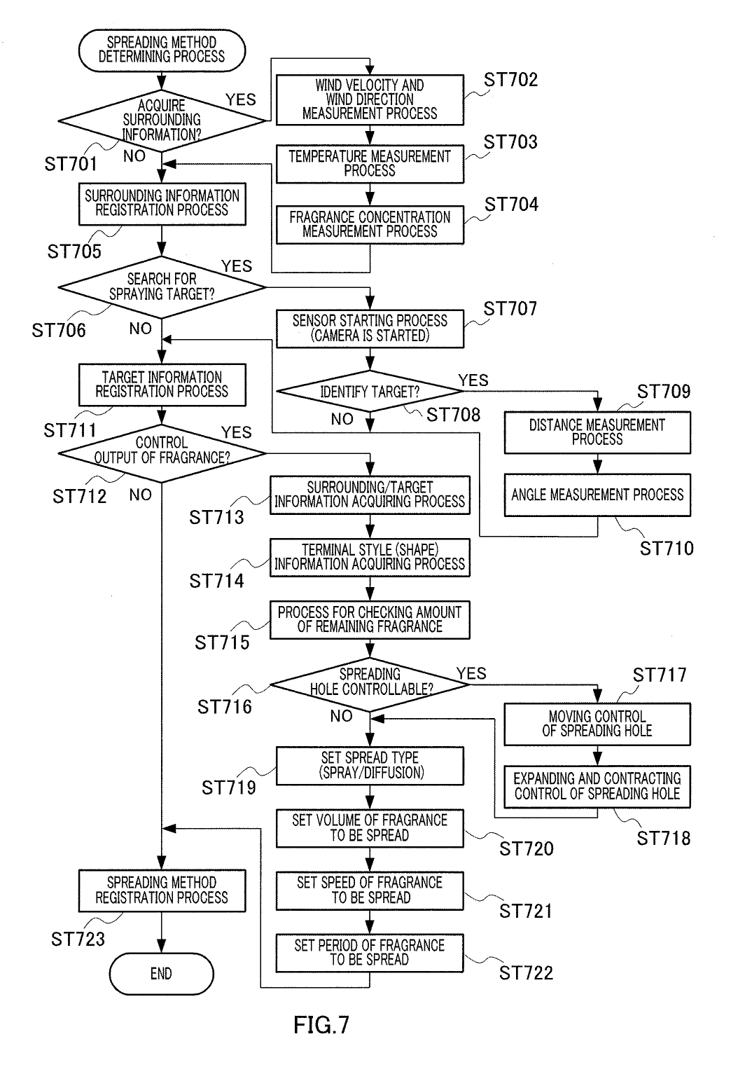

Next, spreading method determining process in step ST 501 will be described. FIG. 7 shows a flow chart of the operations of this spreading method determining process. In the spreading method determining process, first, whether or not to acquire information related to surrounding mobile terminal apparatus body 100B is decided (step ST 701).

When a decision is made in step ST 701 to acquire information related to surrounding mobile terminal apparatus body 100B, a wind velocity and wind direction measurement process is performed in order to measure the wind velocity and the wind direction around mobile terminal apparatus body 100B (step ST 702). These wind velocity and wind direction around mobile terminal apparatus body 100B can be measured based on noise collected with microphone 154 in sensing section 150. By this means, it is possible to check whether or not the wind velocity and wind direction around mobile terminal apparatus body 100B are suitable for the spread of fragrance and acquire information for determining the fragrance spreading method.

Next, temperature measurement process of measuring the temperature around mobile terminal apparatus body 100B is performed (step ST 703). This temperature around mobile terminal apparatus body 100B can be measured by a temperature sensor (not shown). By performing this temperature measurement process, it is possible to decide whether or not the user of mobile terminal apparatus body 100B, who is a target to which fragrance is spreading, stays near mobile terminal apparatus body 100B.

Next, fragrance concentration measurement process of measuring the concentration of the fragrance around mobile terminal apparatus body 100B is performed (step ST 704). This concentration of the fragrance around this mobile terminal apparatus body 100B can be measured based on the fragrance detection level in fragrance sensor of sensing section 150. By this means, it is possible to check whether or not the fragrance is wafting that, if the fragrance is mixed with fragrance to be spread next around mobile terminal apparatus body 100B, produces a bad smell and acquire information for determining the optimal fragrance spreading method.

Then, after the above-described wind velocity and wind direction measurement process, temperature measurement process and fragrance concentration measurement process are complete, or when a decision is made in step ST 701 not to acquire information related to surrounding mobile terminal apparatus body 100B, a surrounding information registration process of registering the information related to surrounding mobile terminal apparatus body 100B is performed (step ST 705). This surrounding information is stored in memory 190 in mobile terminal apparatus body 100B.

Next, whether or not to search for a spraying target (e.g. the user's face) to which the fragrance is spread (step ST 706). Here, when a decision is made to search for the user to which the fragrance is spread, a sensor starting process is performed, and camera 153 of sensing section 150 is started (step ST 707). Then, a decision is made as to whether or not camera 153 identifies a target to which the fragrance is spread (step ST 708).

When a decision is made in step ST 708 that camera 153 identifies the target, a distance measurement process is performed in order to measure the distance between fragrance spreading section 141 in mobile terminal apparatus body 100B and the target, from the size of the target as photographed by camera 153 (step ST 709). Next, angle measurement process is performed in order to measure the angle of fragrance spread from the spreading hole in fragrance spreading section 141 in mobile terminal apparatus body 100B from the angle of the target as photographed by camera 153 (step ST 710).

Then, after the above-described distance measurement process and the angle measurement process are complete, or when a decision is made in step ST 706 not to search for the spraying target, a target information registration process of registering information about the target for spreading the fragrance is performed (step ST 711). This target registration information is stored in memory 190 in mobile terminal body 100B.

Next, whether or not to control output of fragrance is decided (step ST 712). Here, when a decision is made to control the fragrance output, first, a surrounding/target information acquiring process is performed in order to acquire the surrounding information that has been registered in step ST 705 and the target information that has been registered in step ST 711 (in order to read out memory 190) (step ST 713).

Next, a terminal style (shape) information acquiring process for detecting open/closed state of the openable mobile terminal body 100B in light sensor 155 of sensing section 150 and acquiring terminal style (shape) information, is performed (step ST 714).

Next, a process for checking the amount of remaining fragrance is performed in order to check the remaining amount of fragrance material 121 by a sensor for the amount of remaining fragrance material placed (not shown) in material storing section 120 of spread apparatus body 100A (step ST 715).

Then, after the above surrounding/target information acquiring process, terminal style (shape) information acquiring process and remaining amount of fragrance checking process are complete, whether or not that the spreading hole of fragrance spreading section 141 is controllable is decided (step ST 716). Here, when a decision is made that the spreading hole of fragrance spreading section 141 is controllable, spreading hole moving control is performed in order to move the spreading hole such that the fragrance is spread toward the above-described target from the spreading hole of fragrance spreading section 141 (step ST 717). Further, in this case, the spreading hole is controlled to expand and contract such that the shape of the spreading hole of fragrance spreading section 141 is suitable for the speed of spreading fragrance and the range of spreading fragrance (step ST 718).

Next, after the above moving control and the expanding and contracting control of the spreading hole are complete, or when a decision is made in step ST 716 that the spreading hole of fragrance spreading section 141 cannot be controlled, a spread type is set in order to make a type of spreading fragrance being spread from the spreading hole of fragrance spreading section 141 one of suitable types, that is, a spray type and a diffusion type (step ST 719).

Next, spreading volume setting for setting the volume of fragrance to be spread (step ST 720), spreading speed setting for setting speed of fragrance to be spread (step ST 721), spreading time setting for setting a period of fragrance to be spread (step ST 722) are performed.

Then, after the above spreading volume setting, spreading speed setting, and spreading time setting are complete, or when a decision is made in step ST 712 not to control output of the fragrance, spreading method registration process for registering the fragrance spreading method with the above setting in memory 190 is performed (step ST 723), and, after this process is complete, the spreading method determining process is finished.

As described above, according to communication terminal apparatus 100 of this example, fragrance sensor 151, camera 153, microphone 154, light sensor 155 and position sensor 156 of sensing section 150 detects the situation around mobile terminal body 100B, and based on environment information detected in this sensing section 150, spread/deodorization control section 131 of control section 130 controls spread of fragrance of fragrance spreading section 141. This makes it possible to reduce useless spread of fragrance and reduce the influence on and around the mobile terminal as much as possible according to the situation around mobile terminal body 100B.

For example, with this communication terminal apparatus 100, when a specific target (user) can be identified with camera 153, it is possible to spray the target with fragrance and when the target cannot be identified, it is possible to emit and diffuse fragrance.

Further, with this communication terminal apparatus 100, it is possible to control the speed (intensity) of spreading fragrance and the range of spreading fragrance from the direction, distance and wind direction between the communication terminal apparatus and a specific target detected by fragrance sensor 151, microphone 154, position sensor 156 and so on.

Further, with this communication terminal apparatus 100, based on the detection result in light sensor 155, it is possible to control the spreading hole of fragrance spreading section 141 depending upon the state and situation of and around mobile terminal body 100B.

Further, with this communication terminal apparatus 100, it is possible to set and control a plurality of spreading holes in fragrance spreading section 141. For example, the spreading holes in fragrance spreading section 141 can be fixed or moved arbitrary. For example, such a combination is also possible in which one spreading hole is fixed and the other is movable. Further, spread control is possible such that a plurality of spreading holes in fragrance spreading section 141 are linked based on arbitrary rules.

Further, with communication terminal apparatus 100, it is possible to automatically select the spreading holes in fragrance spreading section 141 according to the shape (style) such as a open or close state of mobile terminal body 100B. That is, it is possible to switch the direction to output fragrance to either outwardly or inwardly with respect to mobile terminal body 100B according to open/closed state of mobile terminal body 100B. By this means, for example, while the user is using the communication terminal apparatus, it is possible to switch the spreading hole of fragrance spreading section 141 to the spreading hole placed in front of the terminal.

Further, with this communication terminal apparatus 100, it is possible to control the shape of the spreading hole in fragrance spreading section 141 such that the shape of the spreading hole changes automatically according to the state of mobile terminal body 100B. By this means, for example, it is possible to change the shape of the spreading hole in fragrance spreading section 141 such that fragrance is spread slowly.

Further, with this communication terminal apparatus 100, user notification including an incoming call and an alarm can be informed by spreading fragrance periodically (intermittently). Further, with this communication terminal apparatus 100, it is possible to replace fragrance material 121 while fragrance is spread. Further, this communication terminal apparatus 100 may have reserve containers for storing fragrance material 121, smoking material 122 and so on.

Further, with this communication terminal apparatus 100, it is possible to detect the amount of remaining fragrance material 121 in material storing section 120 and control the distance of spreading fragrance and spreading area, from the detected information about the amount of remaining fragrance material 121. Further, with this communication terminal apparatus 100, it is possible to count the number of times fragrance material 121 remaining in material storing section 120 is spread based on the detected information about the amount of remaining fragrance material 121, and display this to display section 144, to report this to the user. Further, with this communication terminal apparatus 100, it is possible to automatically access to a site for ordering fragrance material 121 by radio section 160 based on the detected information about the amount of remaining fragrance material 121, and buy the desired fragrance material 121.

Further, with this communication terminal apparatus 100, control section 130 holds the state and surrounding information (information collected from sensing section 150) of mobile terminal body 100B and spread/deodorization control section 131 controls the fragrance spreading method including emitting fragrance to points and spreading fragrance, and controls position and shape of the spreading hole in fragrance spreading section 141, so that it is possible to spread fragrance efficiently.

Further, with this communication terminal apparatus 100, it is possible to repeat spreading a fragrance intermittently at arbitrary intervals and cancel the spread at an arbitrary intervals while a fragrance is spread. Here, when the spread of fragrance is canceled, notification such as an incoming call is carried out by operating sound section 143, display section 144, vibration section 145 and light-emitting section 146, instead of spreading fragrance. By this means, with this communication terminal apparatus 100, it is possible to notify an incoming call and so on by “ringtones” and “vibration” even when the spread of fragrance is canceled. On the other hand, when the spread of fragrance is repeated intermittently at arbitrary intervals, after the fragrance previously spread is deodorized by releasing deodorizer 123 (smoke remover 124 in the case of smoke), the next fragrance may be spread. By this means, it is possible to prevent the fragrance previously spread and the next fragrance from mixing.

Further, with this communication terminal apparatus 100, when fragrance sensor 151 of sensing section 150 detects the fragrance around mobile terminal body 100B, this detected fragrance is compared with the spread conditions set in advance, and a decision is made that the environment of mobile terminal body 100B is not applicable to spreading fragrance, it is possible to stop spreading fragrance. By this means, with this communication terminal apparatus 100, it is possible to stop spreading fragrance in cases where the fragrance concentration in the surroundings is out of a preset reference range, for example, where a strong wind blows around mobile terminal body 100B and the effect on spreading fragrance is not obtained even when the fragrance is spread, and where the characteristics of the fragrance around mobile terminal body 100B does not match the fragrance to be spread by the next request. When the fragrance spread previously and the fragrance to be spread by the next request are not compatible, by spreading a substitute fragrance that matches the fragrance spread previously, a bad smell generated by mixing the fragrances may be prevented.

Further, with this communication terminal apparatus 100, it is possible to detect fragrance around mobile terminal body 100B in fragrance sensor 151 of sensing section 150 and control the amount of fragrance spread. By this means, with this communication terminal apparatus 100, when the concentration of fragrance around mobile terminal body 100B reaches a preset reference range, it is possible to stop spreading fragrance automatically. Further, with this communication terminal apparatus 100, when the concentration of the fragrance around mobile terminal body 100B becomes a reference value or less, it is also possible to restart the spread of fragrance automatically.

Further, with this communication terminal apparatus 100, it is possible to detect fragrance around mobile terminal body 100B in fragrance sensor 151 of sensing section 150, issue a spray of deodorizer 123 in deodorizer spraying section 113 and deodorize the detected fragrance. By this means, with this communication terminal apparatus 100, after the fragrance detected in fragrance sensor 151 is deodorized, it is possible to spread the next fragrance automatically, and prevent the fragrance spread previously and the fragrance to be spread next from mixing. At this time, it is possible to control the period in which deodorizer spraying section 113 issues a spray of deodorizer 123 according to fragrance concentration around mobile terminal body 100B. By this means, it is possible to control the period in which the spreading fragrance is deodorized.

Further, with this communication terminal apparatus 100, it is possible to stop a fragrance spreading request in conjunction with a specific operation such as pressing keys in user interface 170 and controls the battery level decision in mobile terminal body 100B. By this means, with this communication terminal apparatus 100, it is possible to set the “silent mode” of fragrance, for example, when fragrance sensor 151 of sensing section 150 detects a specific fragrance, it is possible to stop spreading fragrance after that. In this case, by conducting predetermined steps of clearing by pressing specific keys and so on in user interface 170 and by passing a predetermined time using timer 180 and alarms for example, it is possible to clear the cancellation of the spread of fragrance.

Further, with this communication terminal apparatus 100, when the remaining amount of predetermined fragrance material 121 reaches a predetermined storing amount or less, it is possible to cancel spreading the fragrance or adjust the amount of fragrance to be spread. In this case, an incoming call and so on may be notified by different types of fragrances having a sufficient remaining amount, sound in sound section 143, vibration in vibration section 145, light in light-emitting section 146 and so on instead. Further, in this case, the user may select whether or not to notify an incoming call and so on using fragrance. Furthermore, in this case, information about the amount of remaining fragrance and the time fragrance material 121 is exchanged may be notified to the user by sound in sound section 143, display in display section 144, vibration in vibration section 145, light in light-emitting section 146 and so on.

Further, with this communication terminal apparatus 100, spread/deodorization control section 131 of control section 130 controls fragrance spreading section 141 of notification section 140, fan section 111, sucking section 112 and deodorizer spraying section 113 of spread canceling section 110, to control the spread and deodorization of fragrance material 121 in material storing section 120. Similar to this, smoke production/smoke removal control section 132 of control section 130 controls smoke production section 142 of notification section 140, and fan section 111 and sucking section 112 of spread canceling section 110, thereby controlling the production of smoke and the smoking removal of smoke material 122 in material storing section 120. In this way, when a user notification such as an incoming call and an alarm is controlled by producing smoke, the timings of producing smoke may be adjusted so as to synchronize the sound in sound section 143, display in display section 144, vibration in vibration section 145, light in light-emitting section 146 and so on. Further, in this case, upon spreading fragrance, the spread of fragrance may be notified by producing smoke. Furthermore, in this case, the color of smoke may vary depending on the type of fragrance to be spread.

Further, with this communication terminal apparatus 100, it is possible to cancel spreading fragrance and smoke according to the amount of light detected by light sensor 155. Therefore, with this communication terminal apparatus 100, it is possible to detect, for example, whether or not it is likely to spread fragrance and smoke uselessly in the night the user sleeps, and whether or not the spread of fragrance and smoke may cause trouble with others in a movie theater, from the amount of light detected in light sensor 155, and prevent fragrance and smoke from being spread uselessly.

Further, according to this communication terminal apparatus 100, it is possible to cancel the spread of fragrance and smoke according to the level of noise detected with microphone 154. Accordingly, with this communication terminal apparatus 100, for example, when the spread of fragrance and smoke is useless in strong winds, the wind velocity around the terminal is detected from the noise level in microphone 154, so that it is possible to prevent fragrance and smoke from spreading uselessly.

Further, according to this communication terminal apparatus 100, it is possible to cancel spreading fragrance and smoke according to the position detected in position sensor 156. Therefore, with this communication terminal apparatus 100, it is possible to decide whether or not it is possible to spread fragrance and smoke from the current position of mobile terminal body 100B detected in position sensor 156 using GPS functions, and control the spread of the fragrance and smoke.

Further, with this communication terminal apparatus 100, the direction of spreading fragrance can be adjusted so that fragrance is spread toward a target as photographed by camera 153. Therefore, with this communication terminal apparatus 100, it is possible to restrict the target to which fragrance is spread by the spreading direction adjustment functions and notify the user of an incoming call reliably using fragrance without spreading fragrance uselessly.

### INDUSTRIAL APPLICABILITY

The communication terminal apparatus according to the present invention can prevent fragrance from being spread uselessly and having influence on and around the terminal depending upon situations, and therefore is suitable for use in communication terminal apparatuses having fragrance spread functions, mobile phones for example.

1. A communication terminal apparatus comprising:
a fragrance spreading section that spreads fragrance by a predetermined spread request;
a sensing section that acquires environment information about an environment in which the fragrance spreading section spreads the fragrance; and
a spread control section that controls spread of the fragrance in the fragrance spreading section based on the environment information acquired in the sensing section.

2. The communication terminal apparatus according to claim 1, wherein:
the sensing section has a spreading target detecting sensor for detecting a target to which the fragrance is spread; and
the spread control section controls the fragrance spreading section such that fragrance spreading section spreads the fragrance toward the target to which the fragrance is spread and which is detected in the spreading target detecting sensor.

3. The communication terminal apparatus according to claim 2, wherein, when the spreading target detecting sensor fails to detect the target to which the fragrance is spread, the spread control section controls the fragrance spreading section such that the fragrance spreading section emits and diffuses the fragrance.

4. The communication terminal apparatus according to claim 2, wherein the sensing section comprises:
a position sensor that detects a direction and a distance of the communication terminal apparatus for the target to which the fragrance is spread; and
a wind direction sensor that detects a wind direction around the communication terminal apparatus,
wherein the spread control section controls the speed and a range of spreading fragrance in the fragrance spreading section according to the detection result of the position sensor and the wind direction sensor.

5. The communication terminal apparatus according to claim 1, wherein:
the fragrance spreading section has a plurality of spreading holes for spreading the fragrance; and
the spread control section controls the fragrance spreading section such that the fragrance spreading section selects spreading holes to be operated among the plurality of spreading holes and spreads the fragrance.

6. The communication terminal apparatus according to claim 5, wherein:
the sensing section comprises an open and closed sensor that detects an open or closed state of an openable terminal;
the plurality of spreading holes comprise:
an outer spreading hole that spreads fragrance outwardly with respect to a state the openable terminal is closed; and
an inner spreading hole that spreads fragrance inwardly with respect to the state the openable terminal is open; and
the spread controls section selects one of the outer spreading hole and the inner spreading hole according to the open or closed state of the openable terminal.

7. The communication terminal apparatus according to claim 5, wherein a shape of the spreading holes is configured to be variable.

8. The communication terminal apparatus according to claim 1, further comprising a sensor for the amount of remaining fragrance material that detects the amount of a remaining fragrance material spreading from the fragrance spreading section,
wherein the spread control section controls distance of spreading the fragrance and a range of spreading the fragrance in the fragrance spreading section according to the amount of a remaining fragrance material detected in the a sensor for the amount of remaining fragrance material.

9. The communication terminal apparatus according to claim 8, further comprising a reporting section that counts and reports how many more times the remaining fragrance material is spread based on the amount of the remaining fragrance material detected in the sensor for the amount of remaining fragrance material.

10. The communication terminal apparatus according to claim 1, further comprising:
a smoke production section that spreads smoke by a predetermined spread request;
a smoke sensor that acquires environment information about an environment in which the smoke production section spreads the smoke; and
a smoke production control section that controls spread of the smoke in the smoke production section based on the environment information acquired in the smoke sensor.
